(19) United States
(12) Patent Application Publication
(10) Pub. No.: US 2007/0101593 A1
(43) Pub. Date: May 10, 2007

(54) Ultrasonic distance measuring apparatus with a laser-aiming level system

(75) Inventor: Chi-Yee Jang, Taichung (TW)

Correspondence Address: Mei-Chi Chen, P.O. BOX 215, TAICHUNG, TW

(73) Assignee: Mei-Chi Chen

(21) Appl. No.: 11/270,488

(22) Filed: Nov. 10, 2005

(51) Int. Cl. G01C 15/00

(52) U.S. Cl. 33/286

(57) ABSTRACT

An Ultrasonic distance measuring apparatus with a laser-aiming level system includes an ultrasonic device for detecting the distance from a target, a laser aiming and a level device for adjusting the position of said apparatus on the same level or a determined angle to a target, and a processing unit for determining said distance and controlling said laser-aiming device, said ultrasonic device and a display device. By said laser aiming device and said level device for adjusting the position of said ultrasonic distance measuring apparatus can accurately measure the length, the area and the volume of a target object or space.

### FIELD OF THE INVENTION

The present invention relates to a distance-measuring device. More particularly, the invention relates to an ultrasonic distance measuring apparatus.

### DISCUSSION OF THE BACKGROUND ART

An ultrasonic or sonic measuring device has been invented to measure the distance between a target and a base of the measuring device for difference purpose. For examples of some of such earlier devices are shown in patents to Sindle, U.S. Pat. No. 4,015,232; Newman, U.S. Pat. No. 4,584,676; Lau, U.S. Pat. No. 4,675,854; Farmer, et al., U.S. Pat. No. 4,572,253; Davudson, U.S. Pat. No. 5,163,323.

A laser-aiming level device has been invented to measure the level and the distance of a target to a base by the laser signals. For examples of some of such earlier devices are shown in patents to Ehbets, U.S. Pat. No. 5,949,531 and Shafer, U.S. Pat. No. 6,459,483.

### ADVANTAGES OF THE INVENTION

Considering the price and practicability, a laser-aiming level distance measuring device is more expansive and more accurate in the measurement than an ultrasonic distance measuring device. Therefore, a new invention combines an ultrasonic system for measuring and a laser-aiming level system for aiming and leveling to a target object is a practical new invention for which can increase the accurate of the ultrasonic measurement, and convenience for a user to target on an object and reducing the price as comparing with a laser distance measuring system. The new invention can offer to produce a small, easy carried and multi-functional distance measuring apparatus.

### SUMMARY OF THE INVENTION

According to one aspect of the present invention, an apparatus comprises an ultrasonic device for detecting the distance, a laser-aiming device for aiming, a level device for indicating any determined angle and a processing unit for processing data and controlling all said devices.

An ultrasonic device transmits and receives the ultrasonic signal through a cone tube which limits the diverging angle of an ultrasonic beam less than 15 degree. A laser-aiming device sends out a laser beam for aiming a target, which beam axis is parallel with an axis of said ultrasonic beam and at least a datum plane set on the base. The laser axis guides to target on an object and a level device indicates a determined angle to the same level of a targeted object. There are two magnets set on the bottom, for which main body can magnetically attach on an iron surface. A processing unit processes the data detected from said ultrasonic device and controls all said devices. By choosing a different functional procedure, a processing unit can calculate a segment length, a sum length of two segments, an area and a volume of a target object or space and output the result to a display device.

### BRIEF DESCRIPTION OF THE DRAWINGS

FIG. 1 is a right side view of a preferred embodiment of the present invention;

FIG. 2 is a projective view of the disassembled apparatus show in FIG. 1;

FIG. 3 is a view of the angle level show in FIG. 1;

FIG. 4 is a bottom view of the apparatus show in FIG. 1;

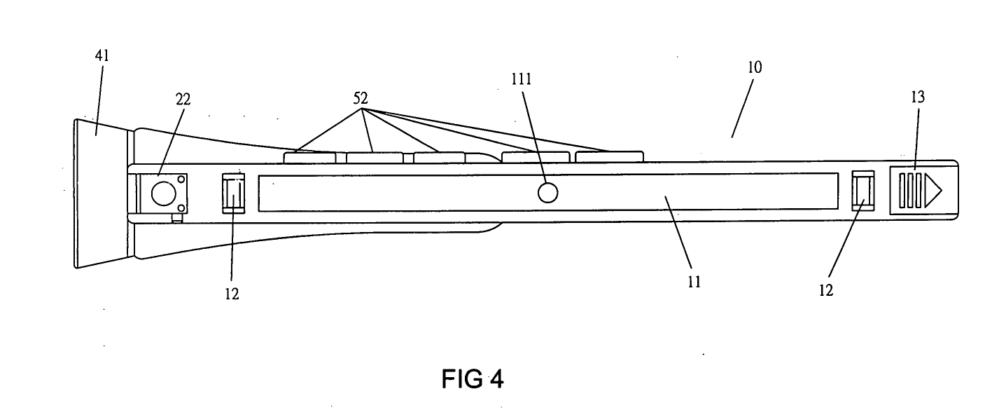

FIG. 5 is a side view of the cross-hair lens device show in FIG. 2;

FIG. 6 is a projective view for showing an ultrasonic beam and a laser-aiming beam aim on a target surface.

### DETAILED DESCRIPTION OF THE PREFERRED EMBODIMENT

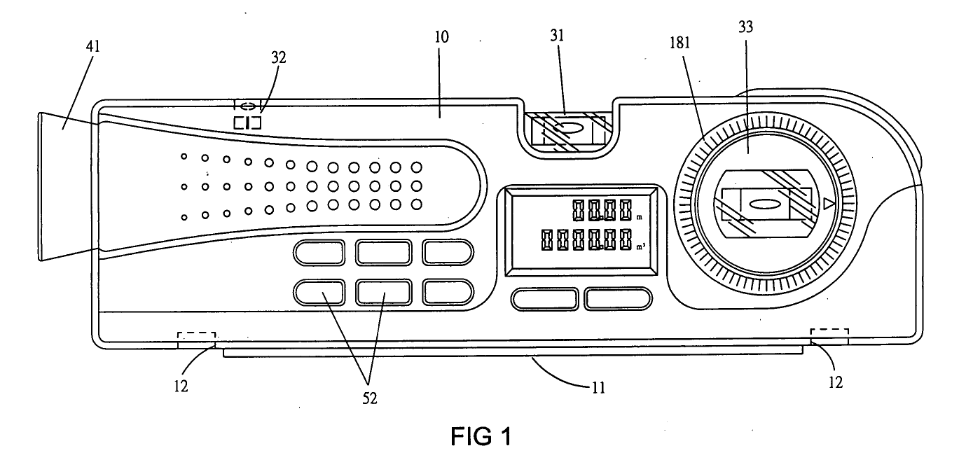

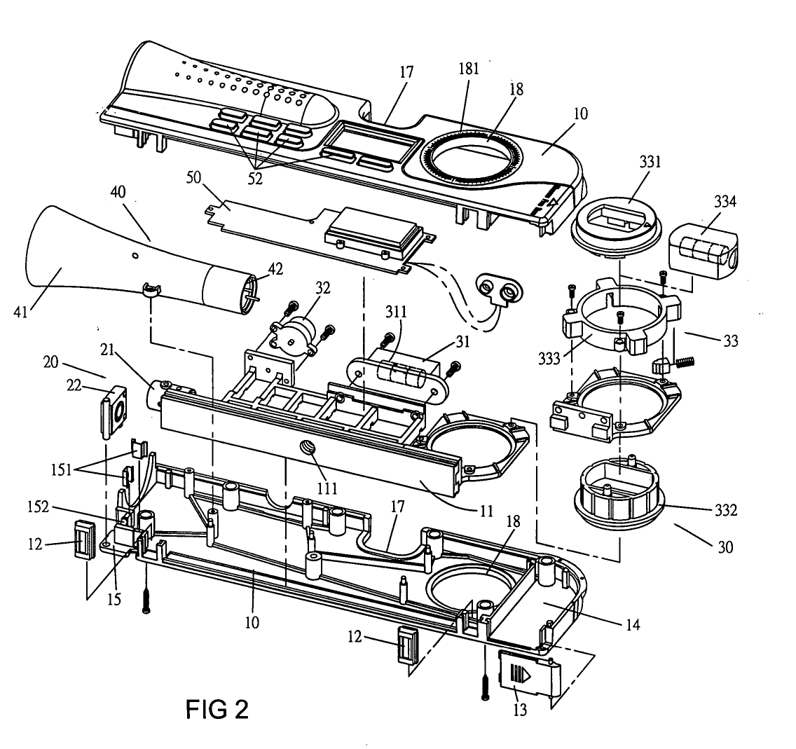

In accordance with the basic layout which can be seen from the FIGS. 1 and 2, the ultrasonic distance measuring apparatus with laser-aiming level system includes a main body 10, a laser-aiming device 20, a level device 30, a ultrasonic device 40 and a processing unit 50.

As show in FIG. 2, a main body 10 contains a space for a laser-aiming device 20, a horizontal level 31, a circle center level 32, an angle level 33, an ultrasonic device 40 and a processing unit 50. A base as a datum plane includes a flat metal 11 with a screw hole 111 in the center for screwing on a stander and two magnets 12 for magnetic attaching on an iron surface. A right side flat surface of the main body 10 sets as a second datum plane to stand stably on a horizontal flat object, like a table or a floor. A battery cover 13 is set on the bottom for covering a battery space 14.

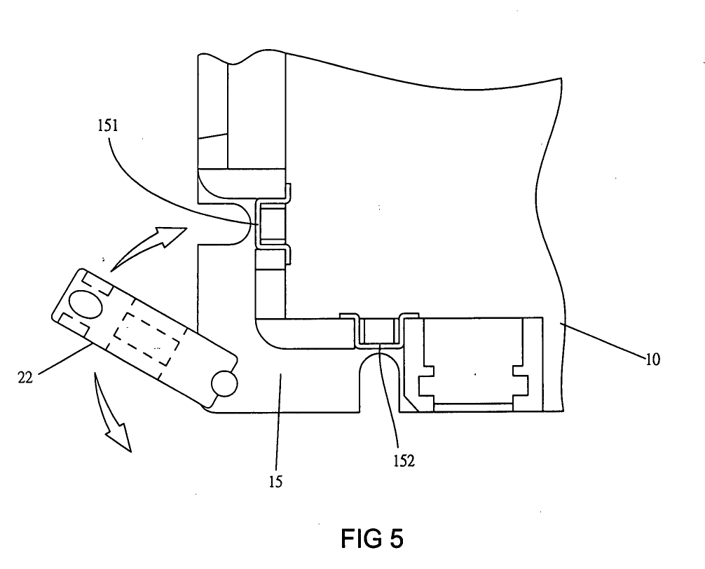

As show in FIGS. 2 and 5, a laser-aiming device 20 includes a laser transmiter 21 and a cross-hair lens device 22 with two magnets, which can be turned to attach on a front iron block 151 for a cross-hair laser beam and to attach on a bottom iron block 152 for a spot dot laser beam as show in FIG. 5. The laser beam can be chose a cross hair or a spot dot for guiding user to aim on an object or a surface.

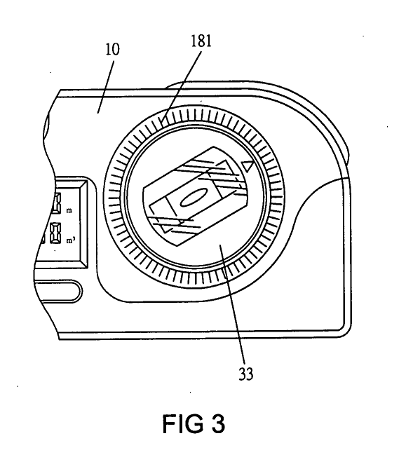

As show in FIGS. 1, 2 and 3, a level device 30 includes a horizontal level 31, a circle center level 32 and an angle level 33. A horizontal level 31 is a tube spirit level 311 located on a three side viewing space 17 of main body 10 for indicating a horizontal level. A circle center level 32 which is a vial round spirit level set on top of the main body 10 for indicating a vertical of the main body 10 to the ground. An angle level 33, which is set in the position 18 of main body 10, comprises a left turntable 331, a right turntable 332, a round frame 333, a tube spirit level 334 in the center and the angle degree 181 around outside of the left turntable 331, for which indicate a determined angle to a ground level.

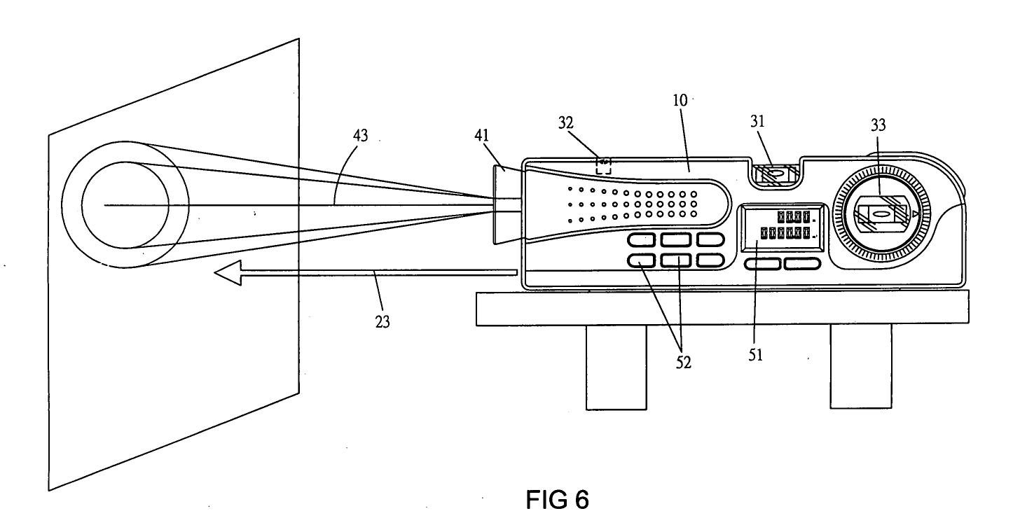

As show in FIGS. 1, 2 and 6, an ultrasonic device 40 comprises a cone tube 41 and a ultrasonic transmitting and receiving speaker 42. A cone tube 41 is a cone shape tube for guiding the ultrasonic beam transmitted and received through a axis of a cone tube 41 to limit in less 15 degree of a diverging angle. An ultrasonic beam axis 43 is parallel with an axis 43 of the laser-aiming beam 23 and the datum plane.

As showing in FIG. 1, a processing unit 50 comprises a microprocessor, a laser device controlling circuit, an ultrasonic device controlling circuit, an ultrasonic speaker circuit, a signal detecting circuit, a power circuit, a LCD device controlling circuit and a function key controlling circuit. A microprocessor mainly according preset software to analyze and operate the procedures for initiating the circuits to function a laser-aiming device 21, an ultrasonic speaker 42, and a LCD device. A set of function keys 52 includes a power key for turning on/off the power, a detecting key for detecting a distance, a backward key for backward to a previous status, a feet/meter key for swapping the feet unit or the metric unit, a one-segment key for functioning one line segment measuring, a two-segment key for measuring two line segment to get a sum length, an area key for measuring a length and a width to get an area and a volume key for measuring a length, a width and a height to get a volume.

What is claimed is:

1. An apparatus for aiming an ultrasonic beam and a laser-aiming beam to a target for measuring a distance between a target and the base of said apparatus on a determined angle or the same level with a target object, comprising:
an ultrasonic device for transmitting a ultrasonic beam and receiving echoes;
a laser aiming device for aiming at least a laser beam and a beam axis paralleling with said ultrasonic beam axis to a target;
a level device for adjusting said laser beam axis on a determined angle or the same level with said target;
a processing unit for determining a distance by the ultrasonic echo signal data which detects from said ultrasonic device, according to a different procedures to calculate the area and volume of the target, and controlling said ultrasonic device, laser aiming device, and a display device.

2. An apparatus as claimed in claim 1 wherein said ultrasonic beam axis and said laser-aiming beam axis are parallel to at least a datum plane, which is set on the base of a housing case of said apparatus.

3. An apparatus as claimed in claim 2 wherein said datum plane comprises a flat metal on bottom surface and two magnets in front and rear of said flat metal, which said apparatus can magnetically attach on an iron surface.

4. An apparatus as claimed in claim 1 wherein said laser aiming device comprises a cross-hair lens device for generating a laser beam cross-hair having a center along said laser sight line.

5. An apparatus as claimed in claim 4 wherein said cross-hair lens device can be switch on or off to turn a laser light to a cross hair or a spot dot.

6. An apparatus as claimed in claim 1 wherein said level device includes a horizontal level, a circle center level and an angle level.

7. An apparatus as claimed in claim 6 wherein said horizontal level is coaxially parallel with said laser-aiming beam axis for adjusting said laser-aiming beam axis through a target on the same level.

8. An apparatus as claimed in claim 7 wherein said horizontal level set on the top side of said apparatus with three viewing windows allowing user to observe it by top side, right side and left side.

9. An apparatus as claimed in claim 6 wherein said circle center level set on the top side of said apparatus for adjusting the vertical of said apparatus on a horizontal plane.

10. An apparatus as claimed in claim 6 wherein said angle level includes a turntable, of which plane is vertical to a base datum plane and parallel to said laser-aiming beam axis, and a tube spirit level which sets inside of said turntable with degrees marked around said circle turntable, which allows said apparatus to set on any determined degree or the same level with said target.

11. An apparatus as claimed in claim 10 wherein the center of said angle level sets on said ultrasonic beam axis with two viewing windows which allow observer to observe the level from left side and right side.

12. An apparatus as claimed in claim 1 wherein said ultrasonic device comprises a ultrasonic transmitting and receiving device and a cone tube for guiding said ultrasonic beam to diverge in a limited angle on said ultrasonic beam axis.

13. An apparatus as claimed in claim 1 wherein said processing unit comprises a microprocessor, a laser device controlling circuit, a ultrasonic device controlling circuit, an ultrasonic speaker circuit, an ultrasonic signal detecting circuit, a power circuit, a data display device controlling circuit and a function key controlling circuit.
